(19) United States
(12) Patent Application Publication
(10) Pub. No.: US 2010/0022128 A1
(43) Pub. Date: Jan. 28, 2010

(54) RECEPTACLE AND PLUG CONNECTOR ASSEMBLY

(75) Inventor: Shu-Man CHIANG, Tu-Cheng City (TW)

Correspondence Address: Muncy, Geissler, Olds & Lowe, PLLC, P.O. BOX 1364, FAIRFAX, VA, 22038-1364, US

(73) Assignee: Cheng Uei Precision Industry Co., Ltd.

(21) Appl. No.: 12/178,900

(22) Filed: Jul. 24, 2008

(51) Int. Cl. H01R 13/648; H01R 24/00

(52) U.S. Cl. 439/607.01; 439/676

(57) ABSTRACT

A receptacle and plug connector assembly includes a receptacle having a housing with a plurality of terminals received therein and a plug mated with the receptacle and having an insulator with a plurality of contacts disposed therein. Each terminal has a base portion and two elastic arms extending from the base portion. Free ends of the two elastic arms respectively protrude towards each other to form projections. Each contact has a substantially U-shaped contacting portion received between the elastic arms and pressed by the projections of the elastic arms. Therefore, the terminals of the receptacle contact the contacts of the plug stably.

### BACKGROUND OF THE INVENTION

1. Field of the Invention

The present invention relates to a receptacle and plug connector assembly, and more particularly to a receptacle and plug connector assembly capable of always ensuring a stable electrical connection between a receptacle and plug thereof.

2. The Related Art

A conventional receptacle and plug connector assembly includes a receptacle having a housing and a plurality of terminals received in the housing, and a plug having an insulator and a plurality of contacts disposed in the insulator and exposed partially out of the insulator. When the receptacle mates with the plug, the terminals electrically connect with the contacts to transmit signal between the receptacle and the plug.

The terminal of a conventional receptacle contacts only one side of the contact of the plug to achieve electrical connection therebetween. Though the connection structure between the terminal of the receptacle and the contact of the plug is simple, this will cause unsteady connection between the terminals and corresponding contacts, and as a result, the terminal of the receptacle and the contact of the plug would more likely be disconnected from each other when the assembly is accidentally subject to an external force. Therefore the assembly cannot transmit signal stably.

### SUMMARY OF THE INVENTION

An object of the present invention is to provide a receptacle and plug connector assembly capable of always ensuring a stable electrical connection between a receptacle and plug thereof. The receptacle and plug connector assembly includes a receptacle having a housing with a plurality of terminals received therein and a plug mated with the receptacle and having an insulator with a plurality of contacts disposed therein. Each terminal has a base portion and two elastic arms extending from the base portion. Free ends of the two elastic arms respectively protrude towards each other to form projections. Each contact has a substantially U-shaped contacting portion received between the elastic arms of the terminal and pressed by the projections of the elastic arms.

As described above, the U-shaped contacting portions of the contacts are received between the elastic arms of the terminals and pressed by the projections of the elastic arms. The terminals of the receptacle connect with the contacts of the plug stably. Therefore it is avoided that the terminals be disconnected from the contacts when the assembly suffers an outside force.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a receptacle and plug connector assembly according to the present invention;

FIG. 2 is an exploded view of a receptacle of the assembly shown in FIG. 1;

FIG. 3 is a cross-sectional view of a housing of the receptacle shown in FIG. 1 while viewed from a different perspective;

FIG. 4 is a perspective view of a shell of the receptacle shown in FIG. 1.

FIG. 5 is an exploded view of a plug of the assembly shown in FIG. 1; and

FIG. 6 is a cross-sectional view of the receptacle assembled with the plug shown in FIGS. 1-5.

### DETAILED DESCRIPTION OF THE PREFERRED EMBODIMENT

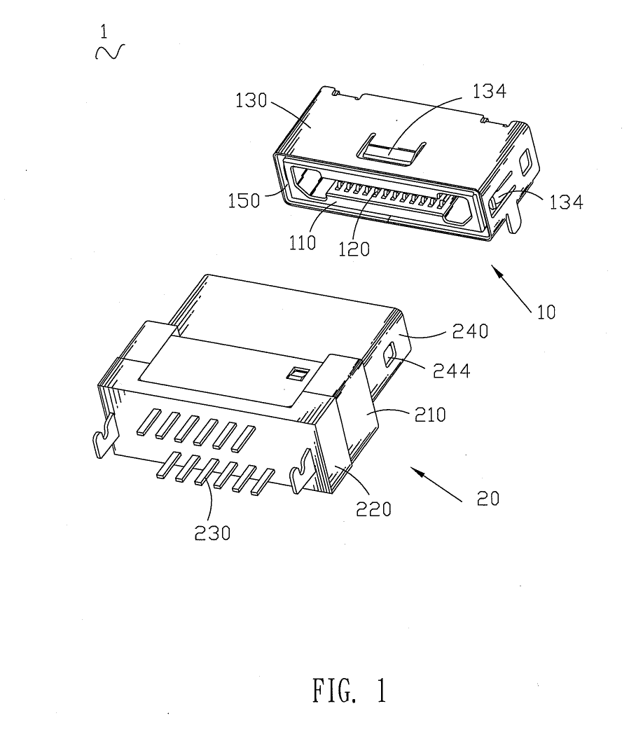

Please Refer to FIG. 1, a receptacle and plug connector assembly 1 according to the invention includes a receptacle 10 and a plug 20 mated with the receptacle 10.

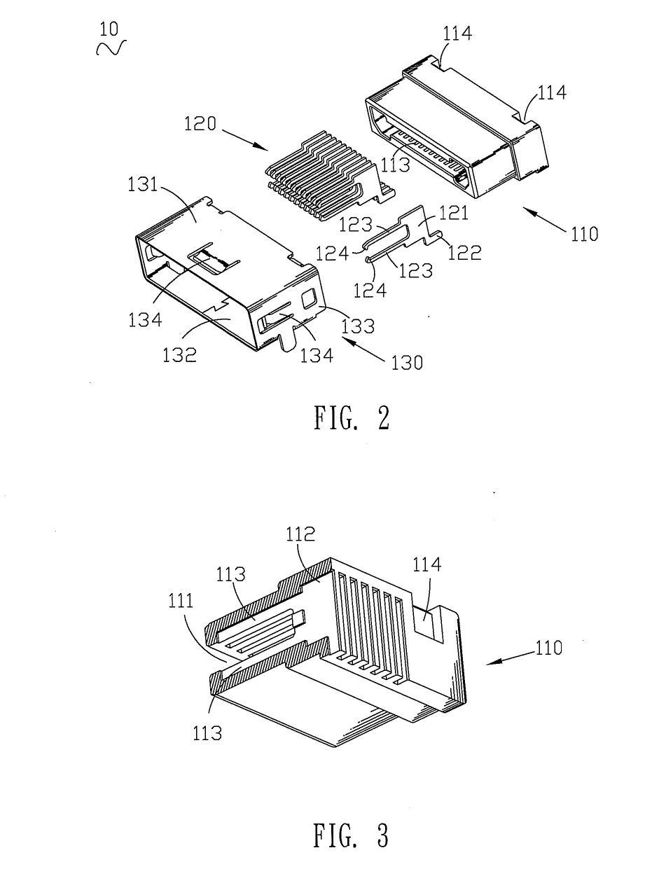

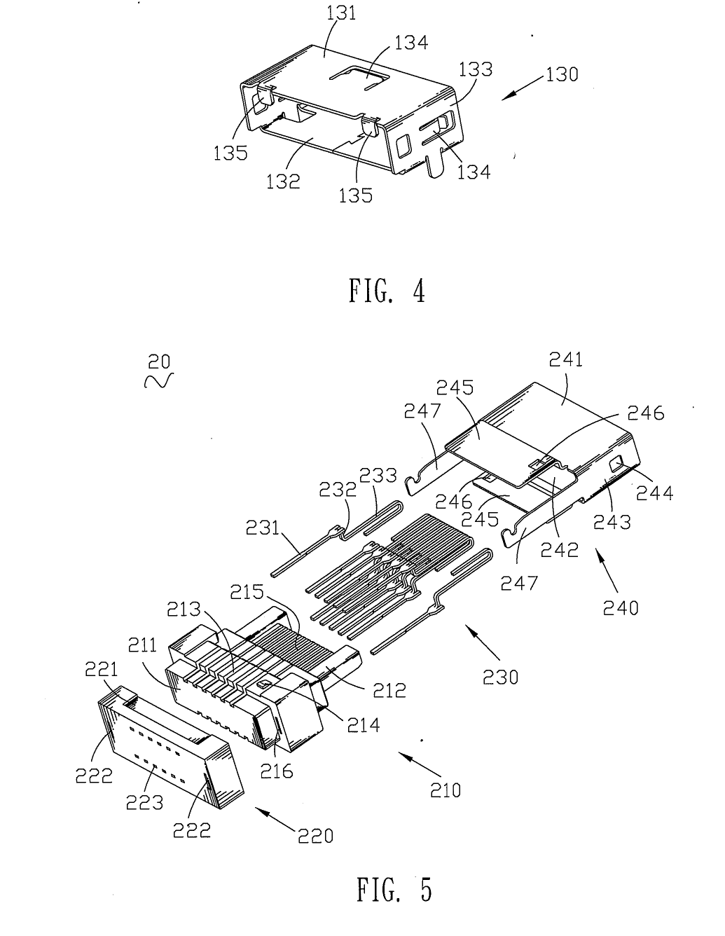

Referring to FIG. 2 to FIG. 4, the receptacle 10 includes a housing 110, a plurality of terminals 120 received in the housing 110 and a shell 130 for holding the housing 110 therein.

The housing 110 defines a receiving cavity 111 and a plurality of terminal chambers 112 each communicating with the receiving cavity 111. Each of the terminal chambers 112 has two passages 113 respectively defined in a top and a bottom of the receiving cavity 111. The rear surface of the housing 110 defines two recesses 114 located at an upper portion thereof and adjacent to two lateral sides of the housing 110.

The terminals 120 are received in the terminal chambers 112 of the housing 110. Each of the terminals 120 has a substantially rectangular base portion 121 and a solder portion 122 extended rearward from a rear end of the base portion 121. The base portion 121 defines two substantially parallel elastic arms 123 both of which extend forward from a front end of the base portion 121. The elastic arms 123 are received in the passages 113 of the housing 110 respectively. Free ends of the two elastic arms 123 respectively protrude towards each other to form a projection 124. The projections 124 extend into the receiving cavity 111 of the housing 110.

The shell 130 has a top wall 131, a bottom wall 132 and two sidewalls 133, which define a space cooperatively for holding the housing 110 therein. A substantially annular receiving space 150 (as shown in FIG. 1) is formed between the shell 130 and the housing 110 for the plug connector 20 to be inserted thereinto. The top wall 131 and the sidewalls 133 respectively define a press portion 134. Free ends of the press portions 134 are crooked. The top wall 131 defines two locking tabs 135 extending towards the bottom wall 132 at a rear end of the top wall 131 and adjacent to the two sidewalls 132 respectively. The locking tabs 135 engage with the recesses 114 of the housing 110.

Referring to FIG. 5, the plug connector 20 includes an insulator 210, a cover 220 disposed at one end of the insulator 210, a plurality of contacts 230 disposed in the insulator 210 and a shielding enclosure 240 mated with the insulator 210.

The insulator 210 has a beam portion 211 protruding forward from a front end and a tongue portion 212 extending rearward from a rear end thereof. A top and bottom surfaces of the insulator 210 respectively define a plurality of elongated grooves 213 running front-to-rear and a substantially wedge-shaped lump 214 disposed at a diagonal line thereon. The tongue portion 212 defines a plurality of substantially U-shaped channels 215 communicating with the grooves 213. The insulator 210 further defines two slots 216 penetrating therethrough and adjacent to two lateral sides of the beam portion 211.

The cover 220 is of a cuboid shape and defines a receiving trough (not shown) at a rear surface for receiving the beam portion 211 of the insulator 210 therein. A substantially rectangular notch 221 is transversely defined at a top surface of the cover 220. The cover 220 further defines two slits 222 and two rows of through holes 223. The two slits 222 are adjacent to two sides of the cover 220 and the holes 223 are defined between the two slits 222.

The contact 230 has a substantially fork-shaped fixed portion 231 received in the groove 213 of the insulator 210. A free end of the fixed portion 231 passes through the groove 213 of the insulator 210 and the through hole 223 of the cover 220 and extends out of the cover 220. A middle portion of a substantially fork-shaped end of the fixed portion 231 extends downward to form a connecting portion 232. A free end of the connecting portion 232 extends rearward and bends downward and then extends forward to form a substantially U-shaped contacting portion 233. The U-shaped contacting portions 223 are received in the U-shaped channels 215 of the insulator 210.

The shielding enclosure 240 has a top board 241, a bottom board 242 and two sideboards 243, which define together a space for holding the tongue portion 212 of the insulator 210 therein. Two fixing holes 244 are defined at the two sideboards 243. The top board 241 and the bottom board 242 respectively extend forward at front ends thereof to form a mantle layer 245. The two mantle layers 245 are respectively covered on the top and the bottom surface of the insulator 210. A front end of the mantle layer 245 is disposed on the notch 221 of the cover 220. Each of the mantle layers 245 defines a location hole 246 at the corresponding position of the wedge-shaped lump 214 of the insulator 210 for fixing the wedge-shaped lump 214 therein. The sideboards 243 respectively extend forward from front ends thereof to form an extending arm 247. Free ends of the two extending arms 247 pass through the slots 216 of the insulator 210 and the slits 222 of the cover 220 and extend out of the cover 220.

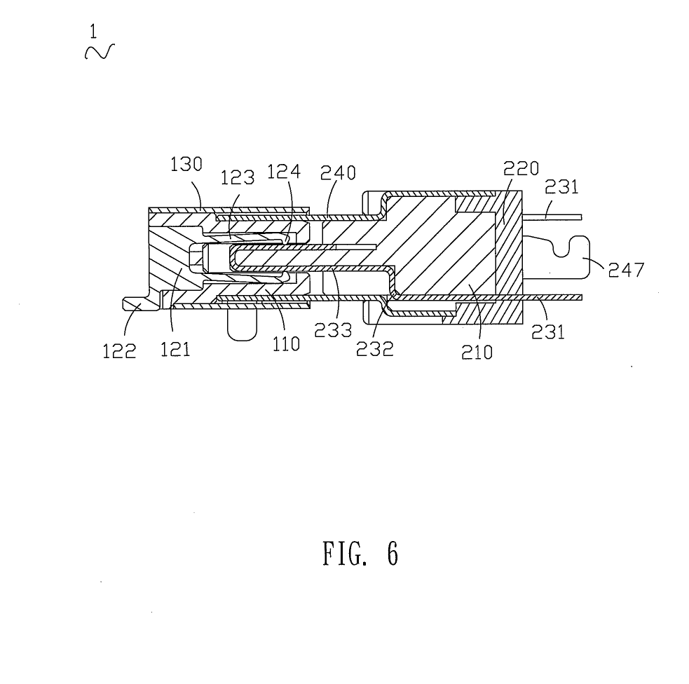

Referring to FIG. 1 and FIG. 6, the plug 20 is assembled with the receptacle 10. The shielding enclosure 240 of the plug 20 is inserted into the receiving space 150. The tongue portion 212 of the insulator 210 is received in the receiving cavity 111 of the housing 110. The U-shaped contacting portions 233 of the contacts 230 are received between the elastic arms 123 of the terminals 120 and pressed by the projections 124 of the elastic arms 123. The press portion 134 of the top wall 131 of the shell 130 press against the top board 241 of the shielding enclosure 240. The two press portions 134 of the sidewalls 133 of the shell 130 are snapped into the fixing holes 244 defined at the sideboards 243 of the shielding enclosure 240.

As described above, the U-shaped contacting portions 233 of the contacts 230 are received between the elastic arms 123 of the terminals 120 and pressed tightly by the projections 124 of the elastic arms 123, which ensures the terminals 130 of the receptacle 10 connect with the contacts 230 of the plug 20 stably, and therefore it is avoided that the terminals 120 be disconnected from the contacts 230 when the assembly 1 is influenced by an external force, such that the signals are transmitted reliably between the receptacle 10 and the plug 20.

What is claimed is:

1. A receptacle and plug connector assembly, comprising:
a receptacle having a housing and a plurality of terminals received in the housing, each terminal having a base portion and two elastic arms extended from the base portion, each free end of the two elastic arms respectively protruding towards each other to form a projection; and
a plug engaged with the receptacle connector, the plug having an insulator and a plurality of contacts disposed in the insulator, each contact having a substantially U-shaped contacting portion received between the two elastic arms and pressed by the projections of the elastic arms.

2. The receptacle and plug connector assembly as claimed in claim 1, wherein the housing of the receptacle defines a receiving cavity therein, the top and the bottom of the receiving cavity define a plurality of passages for receiving the elastic arms of the terminals, the projections of the elastic arms extend into the receiving cavity, the insulator of the plug has a tongue portion received in the receiving cavity, and the tongue portion defines a plurality of substantially U-shaped channels thereon for receiving the U-shaped contacting portions of the contacts.

3. The receptacle and plug connector assembly as claimed in claim 1, wherein the receptacle further includes a shell for holding the housing therein, a substantially annular receiving space is formed between the shell and the housing, the plug further includes a shielding enclosure engaged with the insulator, and the shielding enclosure is inserted into the receiving space.

4. A receptacle, comprising:
a housing defining a receiving cavity therein, a top and a bottom of the receiving cavity defining a plurality of passages; and
a plurality of terminals received in the housing, each terminal having a base portion and two elastic arms extended from the base portion and received in the passages, each of free ends of the two elastic arms respectively protruding towards each other to form a projection to be extended into the receiving cavity.

5. The receptacle as claimed in claim 4, further comprising a shell for holding the housing therein, and a substantially annular receiving space is formed between the shell and the housing.
